(19) United States
(12) Patent Application Publication
(10) Pub. No.: US 2025/0336038 A1
(43) Pub. Date: Oct. 30, 2025

(54) METHOD, DEVICE AND NON-TRANSITORY COMPUTER-READABLE STORAGE MEDIUM FOR ENHANCING VEHICLE SURROUNDING IMAGES

(71) Applicant: Nanning FuLian FuGui Precision Industrial Co., Ltd., Nanning (CN)

(72) Inventor: AI-TUNG HSIEH, New Taipei (TW)

(21) Appl. No.: 18/646,640

(22) Filed: Apr. 25, 2024

(51) Int. Cl. G06T 5/50; G06V 10/10; G06V 10/24; G06V 10/74; G06V 10/98; G06V 20/56

(52) U.S. Cl. CPC G06T 5/50; G06V 10/16; G06V 10/243; G06V 10/761; G06V 10/993; G06V 20/56; G06T 2207/20212; G06T 2207/30168; G06T 2207/30252

(57) ABSTRACT

A method, a device and a non-transitory computer readable storage medium for enhancing vehicle surrounding images, the method comprising: obtaining a plurality of environmental images captured by a plurality of vehicle-mounted cameras, and simultaneously receiving external images captured by external devices. Distinguishing the plurality of environmental images and the external images in to groups of image collections based on different view angles. After selecting a benchmark image of each group of image collections, a preset enhancement processing is utilized to enhance the benchmark image of each the group, and then all the enhanced benchmark images are stitched to generate an enhanced vehicle surrounding image.

### FIELD

A method, device and non-transitory computer-readable storage medium for enhancing vehicle surrounding images.

### BACKGROUND

Currently, the surrounding images equipped in cars are captured by multiple cameras installed on the vehicle, which perform image processing and synthesis at the same time. The closer the surrounding top-down image is to the real scene, the better the driver can grasp the surrounding conditions of the vehicle.

However, the field of view (FOV) of the camera is limited. As the distance from the center of the camera increases, the image details become rougher and distorted due to lens effects. After the image undergoes projection matrix transformation, the blurring phenomenon becomes more severe, especially in the distant projection angles where the image becomes even more blurry. When multiple images are stitched together to form a panoramic image, ghosting artifacts may appear.

### BRIEF DESCRIPTION OF THE DRAWINGS

Implementations of the present technology will now be described, by way of example only, with reference to the attached figures, wherein:

FIG. 1 is a flow chart of a vehicle surrounding image enhancement method according to one embodiment of the present disclosure.

FIG. 2 is a flow chart of one embodiment of a preset enhancement processing of the method of FIG. 1 according to the present disclosure.

FIG. 3 is a block diagram of a vehicle surrounding image enhancement device according to one embodiment of the present disclosure.

### DETAILED DESCRIPTION

It should be understood that the detailed description and specific examples, while indicating exemplary embodiments, are intended for purposes of illustration only and are not intended to limit the scope of the claims.

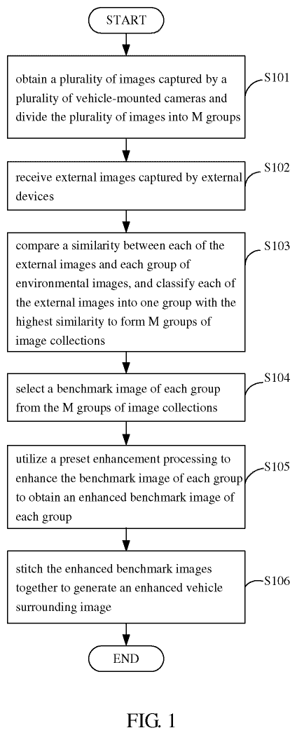

FIG. 1 is a flow chart of a vehicle surrounding image enhancement method in accordance with an embodiment. In this embodiment, the method comprises the steps of:

Step S101, obtains a plurality of images captured by a plurality of vehicle-mounted cameras and divides the plurality of images into M groups of environmental images according to different view angles. Wherein M is a natural number greater than 1. The M groups of environmental images are distinguished based on the perspectives collected by the plurality of vehicle-mounted cameras and can be used to stitch together into a vehicle surrounding images.

The plurality of vehicle-mounted cameras, which are provided at different positions of the vehicle body, are used to capture environmental images from different viewpoints around the vehicle. Wherein the environmental images captured by any two neighboring vehicle-mounted cameras among the plurality of vehicle-mounted cameras have a certain overlapping area.

In one embodiment, the plurality of vehicle-mounted cameras may be fish-eye cameras, and the number of fish-eye cameras may be four, which are distinguished according to the viewing angle or installation location, comprising a front fish-eye camera, a rear fish-eye camera, a left fish-eye camera, and a right fish-eye camera.

It should be noted that the present disclosure does not limit the type and quantity of the plurality of vehicle-mounted cameras. It only requires that the plurality of vehicle-mounted cameras be installed in positions that can capture environmental images within all viewing angles around the vehicle, and the environmental images captured by two neighboring vehicle-mounted cameras have certain overlapping areas.

S102, receives external images captured by external devices. Wherein, the external devices can be other vehicles or roadside units, such as smart light poles, traffic lights, etc. In this embodiment, the own vehicle can communicate with the external devices via the V2X protocol.

Step S103, compares a similarity between each of the external images and each group of environmental images, and classifies each of the external images into one group with the highest similarity to form M groups of image collections.

In one embodiment, before performing step S103, the external images may be pre-processed, for example, fisheye correction and transposed projection.

For example, the images captured by the vehicle-mounted camera are divided into four groups of environmental images corresponding to the front fisheye camera, the rear fisheye camera, the left fisheye camera, and the right fisheye camera. The received external images would be compared with these four groups of images for similarity. Through similarity comparison, each external image will be classified into the group with the highest similarity, forming four groups of image collections.

Step S104, selects a benchmark image of each group from the M groups of image collections.

In one embodiment, the benchmark image of each group may be selected according to image quality. Specifically, the image quality can be determined based on image information of each image, where the image information can include contrast, sharpness, and the like, which is not specifically limited here.

In one embodiment, each image in each group of image collections is stitched separately with environmental images in other groups of image collections to obtain a corresponding pre-stitched image. The benchmark image of each group is selected from each group of image collections according to image quality of the pre-stitched images.

In other embodiments, an image block corresponding to a view angle of each group in each of the pre-stitched images can be configured as an area of interest. The image quality of each image in each group of image collections is ranked according to the image quality of the area of interest of each corresponding pre-stitched image, and the image with the best quality (the highest ranking) is selected as the benchmark image for the group.

Step S105, utilize a preset enhancement processing to enhance the benchmark image of each group to obtain an enhanced benchmark image of each group.

In one embodiment, the preset enhancement processing comprises an enhancement algorithm based on a spatial domain, an enhancement algorithm based on a frequency domain, etc., which are not specifically limited here.

In one embodiment, the preset enhancement processing comprises adjusting those feature parameters such as brightness, white balance, and sharpness of each benchmark image of each group that do not meet the corresponding target values to the corresponding target values to obtain the enhanced image of the benchmark image of each group.

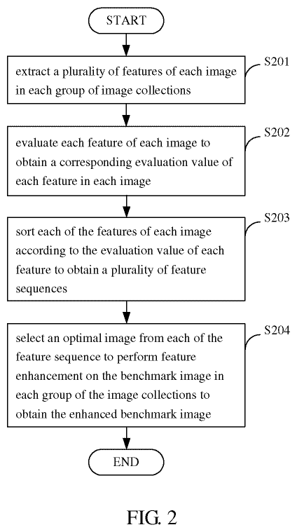

In one embodiment, the flow chart of the preset enhancement processing is shown in FIG. 2. The processing comprises the following steps:

Step S201, extracts a plurality of features of each image in each group of image collections.

In one embodiment, the plurality of features are obtained by performing feature analysis and feature extraction on each image in each group of image collections. Wherein the plurality features comprise at least brightness and sharpness.

In different embodiments, the plurality of features directly related to a user's visual perception can be directly extracted from each image in each group of image collections, comprising features such as hue, saturation, brightness, sharpness, and contrast.

Step S202, evaluates each feature of each image to obtain a corresponding evaluation value of each feature in each image.

In one embodiment, the plurality of features of each image can be input into a deep learning model that has completed training to obtain the corresponding evaluation value of each feature.

In another embodiment, different features can be evaluated using different methods, which are not specifically limited here. For example, for the brightness feature, a brightness mean value of each image is first calculated, and then a corresponding evaluation of the brightness of the image is calculated based on the brightness mean value. Another example is that for the sharpness feature, a gradient algorithm is generally used for sharpness evaluation. Specifically, gradient algorithms such as the Brenner gradient method, the Tenegrad gradient method, the laplace gradient method, the variance method, the energy gradient method, and other gradient algorithms can be used to obtain the corresponding evaluation value of the sharpness.

Step S203, sorts each of the features of each image according to the evaluation value of each feature to obtain a plurality of feature sequences.

Step S204, select an optimal image from each of the feature sequence to perform feature enhancement on the benchmark image in each group of the image collections to obtain the enhanced benchmark image.

For example, in the case of a front vehicle-mounted camera, a group of image collections can be obtained by steps S103 after a similarity comparison between the external images and the environmental images. By step S104, a benchmark image can be obtained. By step S201, at least, a brightness feature and a sharpness feature of each image in the group of image collections can be obtained. By steps S202 and S203, a feature sequence corresponding to the brightness feature and a feature sequence corresponding to the sharpness feature can be obtained. Finally, by step S204, an optimal image of the brightness feature can be obtained from the feature sequence corresponding to the brightness feature, and a brightness feature enhancement of the benchmark image can be performed with the optimal image of the brightness feature. Similarly, from the feature sequence corresponding to the sharpness feature, an optimal image of the sharpness feature can be obtained, and the optimal image of the sharpness feature is used to perform sharpness feature enhancement on the benchmark image. The image finally obtained at step S204 is an enhanced benchmark image in which the benchmark image is feature-enhanced by the optimal image of each feature sequence.

Returning now to FIG. 1, at step S106, the enhanced benchmark image of the groups of image collections are stitched together to generate an enhanced vehicle surrounding image.

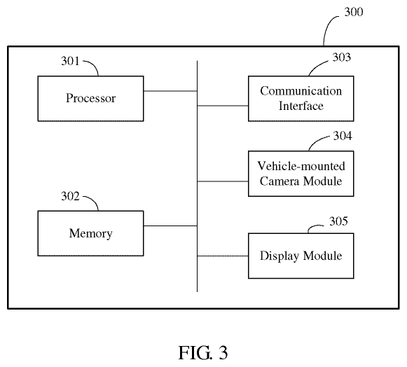

FIG. 3 is a block diagram of a device 300 for enhancing vehicle surrounding image. The device 300 comprises a processor 301, a memory 302, a communication interface 303, a vehicle-mounted camera module 304, and a display module 305. In one embodiment, the device 300 is a vehicle-mounted device, such as a vehicle-mounted controller. It should be understood that the composition of the device 300 shown in the FIG. 3 does not constitute a limitation. Other examples of the device 300 may comprise more or less other hardware or software than those shown in the figures, or have different component arrangements.

In one embodiment, the processor 301 comprises integrated circuits, for example, a single packaged integrated circuit, or multiple integrated circuits with the same function or different functions, including one or a combination of multiple central processing units (Central Processing Unit, CPU), microprocessors, digital processing chips, graphics processors, and various control chips. The processor 301 is the control core (Control Unit) of the device 300, which uses various interfaces and lines to connect various components of the device 300, and runs or executes programs or modules stored in the memory 302. Data stored in the memory 302 can be called up to perform various functions and process data of the mobile device 300, for example, perform a cleaning function to a specified area. The processor 301 is also used to interact with other components.

The memory 302 comprises a read-only memory (Read-Only Memory, ROM), a programmable read-only memory (Programmable Read-Only Memory, PROM), and an erasable programmable read-only memory (Erasable Programmable Read-Only Memory, EPROM), one-time Programmable Read-Only Memory (OTPROM), Electrically-Erasable Programmable Read-Only Memory (EEPROM), CD-ROM (Compact Disc Read-Only Memory, CD-ROM) or other optical disk storage, magnetic disk storage, tape storage, or any other non-transitory computer-readable storage medium that can be used to carry or store data.

The memory 302 stores program codes, and the processor 301 can execute the program codes stored in the memory 302 to perform related functions. For example, the program code of the method flow of FIG. 1 is executed by the processor 301, so as to realize the functions of the various modules to achieve the purpose of enhancing the vehicle surrounding image.

In one embodiment, the memory 302 stores one or more instructions (that is, at least one instruction), and the at least one instruction is executed by the processor 302 to achieve the purpose of enhancing the vehicle surrounding image. For details, refer to FIG. 1 shown.

In one embodiment, the communication interface 303 comprises communication circuitry for communicating date or information with an external device, comprising for receiving external images captured by the external devices.

In one embodiment, the vehicle-mounted camera module 304 comprises a plurality of cameras mounted at different positions on the vehicle body for simultaneously capturing images of the environment around the vehicle. For example, the vehicle-mounted camera module 304 comprises a plurality of cameras disposed at the front, the rear, and the left and right sides of the body of the vehicle, respectively.

In one embodiment, the display module 305 comprises a display mounted at a center control position of the vehicle for displaying an image of the vehicle surround view. In summary, the method, the device and the computer-readable storage medium for enhancing the vehicle surrounding image receive, via a communication network, external images captured by external devices near the vehicle, and after comparing the external images with the environmental images captured by the vehicle-mounted cameras at different viewing angles of the vehicle, selects a image as a benchmark image to be enhanced. Next, a plurality of features are extracted from the external images and the environmental images, and an optimal image of each feature is selected form the plurality of features for feature enhancement of the benchmark image, so that an enhanced benchmark image is obtained for each viewing angle, and finally, the enhanced benchmark images are stitched to generate the enhanced vehicle surrounding image.

It will be apparent to those skilled in the art that various modifications and variations can be made to the disclosure without departing from the scope or spirit of the claims. In view of the foregoing, it is intended that the present disclosure covers modifications and variations, provided they fall within the scope of the following claims and their equivalents.

What is claimed is:

1. A method for enhancing vehicle surrounding images, the method comprising:
obtaining a plurality of images captured by a plurality of vehicle-mounted cameras;
dividing the plurality of images into M groups of environmental images according to different view angles, wherein Mis a natural number greater than 1;
receiving external images captured by external devices;
comparing a similarity between each of the external images and each group of the environmental images;
classifying each of the external images into one group of the environmental images with the highest similarity to form M groups of image collections;
selecting a benchmark image of each group of the M groups of image collections;
utilizing a preset enhancement processing to enhance the benchmark image of each group to obtain an enhanced benchmark image of each group; and
stitching the enhanced images of the M groups of image collections to generate an enhanced vehicle surrounding image.

2. The method of claim 1, wherein the external devices comprise other vehicles and roadside units.

3. The method of claim 1, wherein the method further comprises:
after receiving the external images, preprocessing each of the external image, wherein the preprocessing comprises fisheye correction and transposed projection.

4. The method of claim 1, wherein the selecting a benchmark image of each group of the M groups of image collections further comprises:
determining an image quality of each image of each group of the M groups of image collections;
selecting the benchmark image based on the image quality of each image of each group of the M groups of image collections

5. The method of claim 1, wherein the selecting a benchmark image of each group of the M groups of image collections further comprises:
obtaining a pre-stitched image corresponding to each image in each group of image collections by stitching the each image with environmental images in other groups;
selecting the benchmark image of each group of image collections according to image qualities of the pre-stitched images.

6. The method of claim 5, wherein the selecting the benchmark image of each group of image collections according to image qualities of the pre-stitched images further comprises:
configuring an image block corresponding to a view angle of each group of image collections in each of the pre-stitched images as an area of interest;
ranking each of the pre-stitched images according to an image quality of each the area of interest of each of the pre-stitched images; and
selecting an image with highest ranking as the benchmark image.

7. The method of claim 1, wherein the preset enhancement processing comprises an enhancement algorithm based on a spatial domain, an enhancement algorithm based on a frequency domain.

8. The method of claim 1, wherein the preset enhancement processing comprises:
adjusting feature parameters of the benchmark image that do not meet corresponding target values to the corresponding target values to obtain the enhanced image of the benchmark image, wherein the feature parameters comprise brightness, white balance, and sharpness.

9. A device for enhancing vehicle surrounding images, the apparatus comprising:
a memory storing processor-executable instructions; and
at least one processor coupled to the memory to receive the processor-executable instructions, wherein, upon execution of the processor executable instructions, the at least one processor:
obtains a plurality of images captured by a plurality of vehicle-mounted cameras;
divides the plurality of images into M groups of environmental images according to different view angles, wherein Mis a natural number greater than 1;
receives external images captured by external devices;
compares a similarity between each of the external images and each group of the environmental images;
classifies each of the external images into one group of the environmental images with the highest similarity to form M groups of image collections;
selects a benchmark image of each group of the M groups of image collections;
utilizes a preset enhancement processing to enhance the benchmark image of each group to obtain an enhanced benchmark image of each group; and
stitches the enhanced images of the M groups of image collections to generate an enhanced vehicle surrounding image.

10. A non-transitory computer readable storage medium storing processor-executable instructions which, when executed by at least one processor, cause the at least one processor to perform a method of enhancing vehicle surrounding images, the method comprising:
obtaining a plurality of images captured by a plurality of vehicle-mounted cameras;
dividing the plurality of images into M groups of environmental images according to different view angles, wherein Mis a natural number greater than 1;
receiving external images captured by external devices;
comparing a similarity between each of the external images and each group of the environmental images;
classifying each of the external images into one group of the environmental images with the highest similarity to form M groups of image collections;
selecting a benchmark image of each group of the M groups of image collections;
utilizing a preset enhancement processing to enhance the benchmark image of each group to obtain an enhanced benchmark image of each group; and
stitching the enhanced images of the M groups of image collections to generate an enhanced vehicle surrounding image.
